(19) United States
(12) Patent Application Publication
(10) Pub. No.: US 2026/0064459 A1
(43) Pub. Date: Mar. 5, 2026

(54) STANDARDIZED AND ROBUST FRAMEWORK TO ENHANCE LOG MANAGEMENT AVAILABILITY

(71) Applicant: Quanta Cloud Technology Inc., Taipei City (TW)

(72) Inventors: Hsuan-Ho CHUANG, Taipei City (TW); Cheng-Fu TUAN, Taipei City (TW); Tong-Pai HUANG, Taipei City (TW); Chia-Jui LEE, Taipei City (TW)

(21) Appl. No.: 18/816,091

(22) Filed: Aug. 27, 2024

(51) Int. Cl. G06F 9/48; G06F 8/61

(52) U.S. Cl. CPC G06F 9/4881; G06F 8/61; G06F 2209/486

(57) ABSTRACT

A system includes one or more data processors and a non-transitory computer-readable storage medium containing instructions which, when executed on the one or more data processors, cause the one or more data processors to perform operations. The operations include executing a deployer daemon on an operating system of a local host to maintain operation of at least one instance of combined services, which include a log collection service and a storage and retrieval service. The operations include performing, via a task scheduler executing on the operating system, a cycle of operational status checks on the combined services, and repeating the cycle at a predetermined time interval. The operations further include triggering, via the task scheduler, the deployer daemon to correct a non-operational result if the operational status check returns the non-operational result, and adding an entry, via the task scheduler, into a results file indicative of corrective action taken.

### FIELD OF THE INVENTION

The present invention relates generally to maintaining log management and search services in a computer system, and more specifically, to maintaining at least one operational instance of log management and search services on one of an operating system of a host computer in a network, a container runtime service on the operating system, or a container platform service on the container runtime service.

### BACKGROUND OF THE INVENTION

Log management involves the collection, storage, and analysis of logs generated by various components of a computer system. These components include for example without limitation, the operating system (OS), a container runtime service, or a container platform service. Services such as container platform services include numerous components that perform various functions. The logs provide valuable insights into the status and performance of components of the system, which help in troubleshooting, reducing downtime, and allowing administrators to shift from reactive to proactive monitoring of the system. In a cloud environment, hundreds or even thousands of containers are running at any given time, each with an associated log. To optimize hardware resource utilization and implement automated management, log management services can be containerized and deployed across diverse container platform services including, for example without limitation, Kubernetes®.

However, deploying containerized log management services in the cloud has disadvantages. For example, when a container platform service error causes the container platform service to crash, the services on it can be interrupted. Similarly, when a container runtime service crashes, services running in containers (including container platform services) as well as the behaviors of log management can be affected and interrupted. Container platform or container runtime service crashes cause the logs generated by the crashed platforms (for example, container runtime service status logs, container platform service logs, and other system-related logs) to become useless because log management services cannot be used for searching the logs when a crash occurs. Therefore, a need exists for a system that provides continuous and reliable log management behaviors, especially in a system where log management services are crucial for troubleshooting or monitoring operating system, container runtime service, and container platform service logs.

### SUMMARY OF THE INVENTION

The term embodiment and like terms, e.g., implementation, configuration, aspect, example, and option, are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter. This summary is also not intended to be used in isolation to determine the scope of the claimed subject matter. The subject matter should be understood by reference to appropriate portions of the entire specification of this disclosure, any or all drawings, and each claim.

According to a first aspect of the present disclosure, a system comprises one or more data processors and a non-transitory computer-readable storage medium containing instructions which, when executed on the one or more data processors, cause the one or more data processors to perform operations. The operations include executing a deployer daemon on an operating system of a local host to maintain operation of at least one instance of a combined services. The combined services include a log collection service and a storage and retrieval service. The operations include performing, via a task scheduler executing on the operating system, a cycle of operational status checks on the combined services, and repeating the cycle at a predetermined time interval. The operations further include triggering, via the task scheduler, the deployer daemon to correct a non-operational result if the operational status check returns the non-operational result, and adding an entry, via the task scheduler, into a results file indicative of corrective action taken.

According to a second aspect of the present disclosure, a computer-implemented method, comprises executing a deployer daemon on an operating system of a local host to maintain operation of at least one instance of a combined services. The combined services include a log collection service and a storage and retrieval service. The method includes executing a task scheduler on the operating system. The task scheduler performs a cycle of operational status checks on the combined services. The cycle repeats at a predetermined time interval. The method further includes triggering, via the task scheduler, the deployer daemon to correct a non-operational result if the operational status check returns the non-operational result. An entry is added into a results file to indicate corrective action taken.

According to a further aspect of the present disclosure, a computer-program product tangibly embodied in a non-transitory machine-readable storage medium includes instructions configured to cause a data processing apparatus to perform operations. The operations include executing a deployer daemon on an operating system of a local host to maintain operation of at least one instance of a combined services. The combined services include a log collection service and a storage and retrieval service. The operations include performing, via a task scheduler executing on the operating system, a cycle of operational status checks on the combined services, and repeating the cycle at a predetermined time interval. The operations further include triggering, via the task scheduler, the deployer daemon to correct a non-operational result if the operational status check returns the non-operational result, and adding an entry, via the task scheduler, into a results file indicative of corrective action taken.

The above summary is not intended to represent each embodiment or every aspect of the present disclosure. Rather, the foregoing summary merely provides an example of some of the novel aspects and features set forth herein. The above features and advantages, and other features and advantages of the present disclosure, will be readily apparent from the following detailed description of representative embodiments and modes for carrying out the present invention, when taken in connection with the accompanying drawings and the appended claims.

### BRIEF DESCRIPTION OF THE DRAWINGS

The disclosure, and its advantages and drawings, will be better understood from the following description of representative embodiments together with reference to the accompanying drawings. These drawings depict only representative embodiments, and are therefore not to be considered as limitations on the scope of the various embodiments or claims.

FIG. 1 is a schematic diagram of components of a system that maintains log management services on a local host and in a cloud, according to certain aspects of the present disclosure;

FIG. 2 shows an exemplary cycle of operational checks performed as part of the system of FIG. 1 that maintains log management services, according to certain aspects of the present disclosure;

FIG. 3 shows an exemplary sequence of operations performed by a deployment script to set up the system of FIG. 1 that maintains log management services, according to certain aspects of the present disclosure;

FIG. 4 shows examples of a results file that is generated by steps of the deployment script shown in FIG. 3 and by steps of the cycle of operational checks shown in FIG. 2, according to certain aspects of the present disclosure;

FIG. 5 is an exemplary block diagram of a computer system to implement the processes described herein; and

FIG. 6 is an exemplary block diagram of another computer system to implement the processes described herein.

### DETAILED DESCRIPTION

A system comprises one or more data processors and a non-transitory computer-readable storage medium containing instructions which, when executed on the one or more data processors, cause the one or more data processors to perform operations. The operations include executing a deployer daemon on an operating system of a local host to maintain operation of at least one instance of combined services. The combined services include a log collection service and a storage and retrieval service. The operations include performing, via a task scheduler executing on the operating system, a cycle of operational status checks on the combined services, and repeating the cycle at a predetermined time interval. The operations further include triggering, via the task scheduler, the deployer daemon to correct a non-operational result if the operational status check returns the non-operational result, and adding an entry, via the task scheduler, into a results file indicative of corrective action taken.

Various embodiments are described with reference to the attached figures, where like reference numerals are used throughout the figures to designate similar or equivalent elements. The figures are not necessarily drawn to scale and are provided merely to illustrate aspects and features of the present disclosure. Numerous specific details, relationships, and methods are set forth to provide a full understanding of certain aspects and features of the present disclosure, although one having ordinary skill in the relevant art will recognize that these aspects and features can be practiced without one or more of the specific details, with other relationships, or with other methods. In some instances, well-known structures or operations are not shown in detail for illustrative purposes. The various embodiments disclosed herein are not necessarily limited by the illustrated ordering of acts or events, as some acts may occur in different orders and/or concurrently with other acts or events. Furthermore, not all illustrated acts or events are necessarily required to implement certain aspects and features of the present disclosure.

For purposes of the present detailed description, unless specifically disclaimed, and where appropriate, the singular includes the plural and vice versa. The word “including” means “including without limitation.” Moreover, words of approximation, such as “about,” “almost,” “substantially,” “approximately,” and the like, can be used herein to mean “at,” “near,” “nearly at,” “within 3-5% of,” “within acceptable manufacturing tolerances of,” or any logical combination thereof. Similarly, terms “vertical” or “horizontal” are intended to additionally include “within 3-5% of” a vertical or horizontal orientation, respectively. Additionally, words of direction, such as “top,” “bottom,” “left,” “right,” “above,” and “below” are intended to relate to the equivalent direction as depicted in a reference illustration; as understood contextually from the object(s) or element(s) being referenced, such as from a commonly used position for the object(s) or element(s); or as otherwise described herein.

In an embodiment, a framework 100 enhances and maintains the availability of log management services by seeking to maintain operation of at least one instance of a combination of a log collection service and a storage and retrieval service running on a physical machine, local host, or server. The log collection service can, for example without limitation, be fluentd® or other log collection services with similar capabilities. The storage and retrieval service can, for example without limitation, be OpenSearch® or other storage and retrieval services with similar capabilities. Hereinafter the combination of a log collection service and a storage and retrieval service is referred to as the “combined services.”

To maintain the combined services, in an embodiment, the framework includes two other services directly installed on the operating system of the physical machine, local host, or server: a task scheduler, for example without limitation, a local daemon service such as a cronjob, and a deployer daemon, for example without limitation, a local service on demand. In an embodiment the local daemon service functions to perform operational checks at predetermined time intervals on the operational status of the combined services. Based on the results of the operational checks, the deployer daemon is triggered by the local daemon service to take corrective action, for example, deployment and initiation of the combined services found to be non-operational. In this manner, the services such as log services are maintained despite failure or unavailability of different system components.

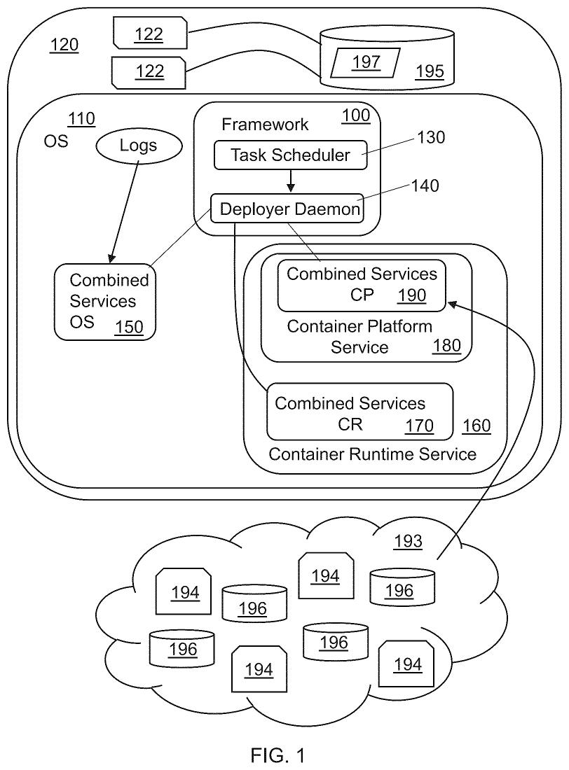

Referring to FIG. 1, in an exemplary embodiment, a framework 100 is illustrated as installed on an operating system (OS) 110 of a local host 120. The exemplary framework 100 comprises a task scheduler 130 and a deployer daemon 140. A first instance of the combined services, labeled as Combined Services OS and identified as reference numeral 150 resides on the operating system 110. A container runtime service 160 is installed on the operating system 110, and a second instance of the combined services, labeled as Combined Services CR and identified as reference numeral 170 is installed on the container runtime service 160. A container platform service 180 is installed on the container runtime service 160, and a third instance of the combined services, labeled as Combined Services CP and identified as reference numeral 190 is installed in the container platform service 180. An external network or cloud 193, for example, of servers 194 and data storage systems 196 is represented as in communication with the Combined Services CP 190 via the container platform service 180.

The local host 120 includes one or more data processors 122. The one or more data processors 122 are illustrated to be communicative with a non-transitory computer-readable storage medium 195. The non-transitory computer-readable storage medium 195 contains instructions which, when executed on the one or more data processors 122, cause the one or more data processors 122 to perform a series of operations that include deployment of the framework 100. In an embodiment the framework 100, in particular the task scheduler 130, dynamically detects the system environment on the local host 120. The system environment includes any instances of the operating system 110, the container runtime service 160, and the container platform service 180. The system environment also includes any instances of the combined services 150, 170, 190 running, respectively, on the operating system 110, the container runtime service 160, and the container platform service 180.

Upon detection of the system environment, the framework 100 initiates corresponding initialization actions. In an example, the framework identifies the operating system 110 as a Linux® OS, the container runtime service 160 as the Docker® service, and the container platform service 180 as a Kubernetes® service. In this example the task scheduler 130 operates as a cronjob, continuously monitoring the health of the Docker® service. The cronjob is, for example, a command that the cron daemon runs at regularly scheduled intervals. The cronjob is also known as a cron schedule because it includes specific instructions about what particular commands should be executed and when the particular commands are executed.

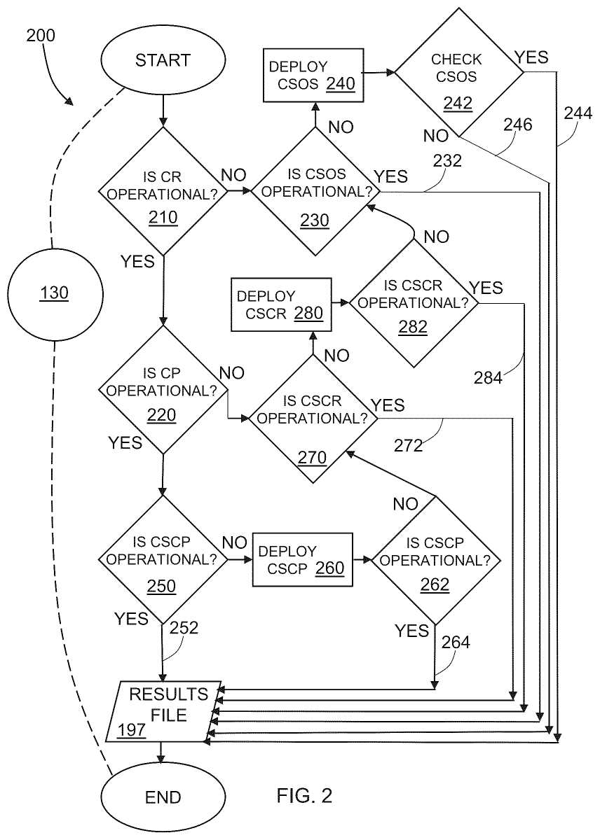

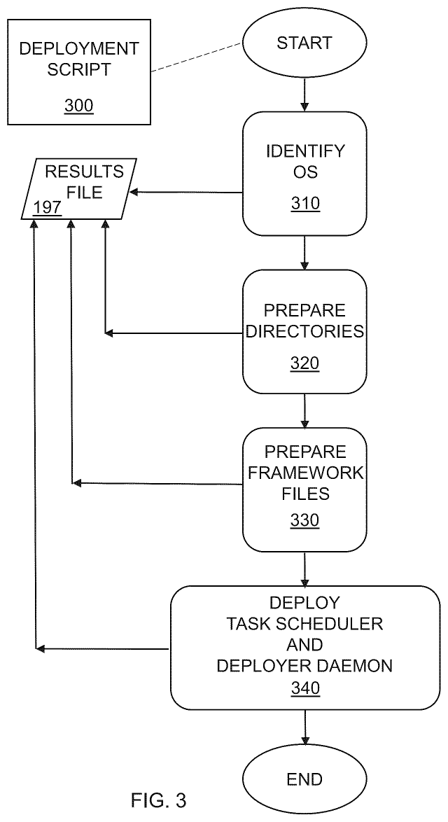

For example, in the Linux® OS, the content of a cronjob may look like “*****start-qlr-check.” This command means to execute the “start-qlr-check” command every minute. The content “start-qlr-check,” for example, is representative of the task scheduler 130 that triggers the START step of the cycle of operational checks 200 shown in FIG. 2. The executable file “start-qlr-check” is one of the framework files illustrated as element 330 in FIG. 3. Still referring to the example Linux® OS, the executable file “start-qlr-check” is a binary executable version of a shell script, located under the DATAPATH defined in the directories at element 320 of FIG. 3.

In other examples, the task scheduler 130 operates as a cronjob continuously monitoring the health of another container runtime service having capabilities similar to the Docker® service. In an example, the task scheduler 130 further operates as a cronjob to continuously monitor the health of the Kubernetes® service. In other examples, the task scheduler 130 operates as a cronjob to monitor the health of another container platform service having capabilities similar to the Kubernetes® service. Other such container platform services can include, for example without limitation, OpenShift® developed by Red Hat®, DOCKER SWARM®, and Nomad by HashiCorp®. In an example the task scheduler 130 further operates as a cronjob to further monitor the health of instances of the combined services 150, 170, 190 as is described herein.

In an example, if the combined services comprise a log collection service such as fluentd® and a storage and retrieval service such as OpenSearch®, upon detecting non-operational services, the task scheduler 130 triggers the deployer daemon to initiate an instance of fluentd® and OpenSearch® re-deployment on at least one of the container runtime service 160, the container platform service 180, and the operating system 110, ensuring continuous log management behavior. The initiated instance thus maintains log management despite the initial non-operational service. This maintenance of log management on the local host 120, in the system environment, and across the cloud 193 via the re-deployment improves the management of the local host 120, the container runtime service 160, and the cloud 193 by ensuring a continuous log. Continuing the example, if the Docker® daemon crashes, the deployer daemon 140 will directly install and run a log collection service such as fluentd® and a storage and retrieval service such as OpenSearch® on the operating system 110. Further continuing the example, if only the container platform service 180 such as Kubernetes® crashes, the deployer daemon 140 can run the log collection service and the storage and retrieval service fluentd® and OpenSearch® using the container runtime service 160 such as Docker®. Overall, the framework 100 enhances log management availability by keeping at least one instance of the combined log collection and storage and retrieval services, for example, fluentd® and OpenSearch® operational.

Referring to FIGS. 1 and 2, in an embodiment, the series of operations include a cycle of operational checks 200 that are executed by the task scheduler 130. The cycle 200 repeats at a predetermined time interval. In an embodiment, the predetermined time interval is about one minute. In other embodiments, the predetermined time interval is less than a minute, for example 10 seconds, 20 seconds, 30 seconds, 40 seconds, or 50 seconds. In other embodiments, the predetermined time interval is more than a minute, for example 2 minutes, 3 minutes, 4 minutes, 5 minutes, or more.

In an embodiment, the deployer daemon 140 is executed on the operating system 110 of the local host 120 to maintain operation of at least one instance of the combined services 150, 170, 190 as shown in FIG. 1. In this context, the task scheduler 130 performs the cycle of operational checks 200 on instances of the combined services 150, 170, 190, configured to operate on at least one of the operating system 110, a container runtime service 160 on the operating system 110, and a container platform service 180 on the container runtime service 160, respectively. If an operational status check returns a non-operational result, in an embodiment, the task scheduler 130 triggers the deployer daemon 140 to take corrective action to correct the non-operational result, for example, the corrective action can include deploying and initiating operation of an instance of the combined services 150, 170, 190. In an embodiment, the task scheduler 130 further updates an entry in a results file 197 (see FIG. 1), that for example, resides on the non-transitory computer-readable storage medium 195, where the entry is indicative of the corrective action taken and/or operational status. The content and format of exemplary entries to the results file 197 are described more fully herein.

Referring to FIG. 2, in an embodiment, each cycle of operations 200 begins at step 210 with a check of whether the container runtime service 160 (in FIG. 1) is operational. If the container runtime service 160 is operational, the task scheduler 130 proceeds to step 220 and performs an operational status check on the container platform service 180 (presented for brevity as “CP” in FIG. 2).

If the container runtime service 160 has a non-operational result at step 210, in an embodiment, the task scheduler 130 proceeds at step 230 to check whether the instance of combined services OS 150 (in FIG. 1) on the operating system 110 (in FIG. 1) (presented for brevity as “CSOS” in FIG. 2) is operational. If the instance of combined services OS 150 on the operating system 110 is not operational, in an embodiment, the task scheduler 130 executes the deployer daemon 140 (in FIG. 1) at step 240 to install and deploy the instance of combined services OS 150 on the operating system 110.

In an embodiment, the task scheduler 130 at step 242 checks whether the just deployed instance of combined services OS 150 on the operating system 110 is operational. Depending on the result of the deployment, in an embodiment, the task scheduler 130 updates the results file 197 with an indication of the status of the just deployed instance of combined services OS 150 on the operating system 110. If the status of the instance of the just deployed combined services OS 150 on the operating system 110 is operational, in an embodiment, at step 244 the task scheduler 130 updates the results file 197 with an indication that the instance of combined services OS 150 on the operating system 110 was deployed and is operational. The cycle 200 then ends. However, if the status of the instance of the just deployed combined services OS 150 on the operating system 110 is not operational, in an embodiment, at step 246 the task scheduler 130 updates the results file 197 with an indication that deployment and operation of the instance of combined services OS 150 on the operating system 110 has failed. The cycle 200 then ends. In an embodiment, if at step 230, the instance of combined services OS 150 on the operating system 110 is operational, the task scheduler 130 at step 232 updates the results file 197 with an indication that the instance of combined services OS 150 on the operating system 110 is operational. The cycle 200 then ends.

Still referring to FIG. 2, in an embodiment, if at step 220 the container platform service 180 (in FIG. 1) is operational, the task scheduler 130 at step 250 performs an operational status check on the instance of combined services CP 190 (in FIG. 1) on the container platform service 180 (presented for brevity as “CSCP” in FIG. 2). If the instance of combined services CP 190 on the container platform service 180 is operational, in an embodiment, the task scheduler 130 at step 252 updates the results file 197 with an indication that the instance of combined services CP 190 on the container platform service 180 is operational. The cycle 200 then ends. If the instance of combined services CP 190 on the container platform service 180 is not operational, in an embodiment, the task scheduler 130 executes the deployer daemon 140 at step 260 to install and deploy the instance of combined services CP 190 on the container platform service 180.

In an embodiment, the task scheduler 130 at step 262 checks whether the just deployed instance of combined services CP 190 on the container platform service 180 is operational. If the status of the instance of the just deployed combined services CP 190 on the container platform service 180 is operational, in an embodiment, at step 264 the task scheduler 130 updates the results file 197 with an indication that the instance of combined services CP 190 on the container platform service 180 was deployed and is operational. The cycle 200 then ends. However, if the status of the instance of the just deployed combined services CP 190 on the container platform service 180 is not operational, in an embodiment, the task scheduler 130 proceeds at step 270 to check whether the instance of combined services CR 170 (in FIG. 1) on the container runtime service 160 (presented for brevity as “CSCR” in FIG. 2) is operational.

In an embodiment, if the instance of combined services CR 170 on the container runtime service 160 is operational, the task scheduler 130 at step 272 updates the results file 197 with an indication that the instance of combined services CR 170 on the container runtime service 160 is operational. The cycle 200 then ends. If the instance of combined services CR 170 on the container runtime service 160 is not operational, in an embodiment, the task scheduler 130 executes the deployer daemon 140 at step 280 to install and deploy the instance of combined services CR 170 on the container runtime service 160.

In an embodiment, the task scheduler 130 at step 282 checks whether the just deployed instance of combined services CR 170 on the container runtime service 160 is operational. If the instance of combined services CR 170 on the container runtime service 160 is operational, in an embodiment, the task scheduler 130 further at step 284 updates the results file 197 with an indication that the instance of combined services CR 170 on the container runtime service 160 was deployed and is operational. The cycle then 200 ends. However, if the instance of combined services CR 170 on the container runtime service 160 is not operational, in an embodiment, the task scheduler 130 proceeds at step 230 to check whether the instance of combined services OS 150 on the operating system 110 is operational. Steps in the cycle 200 that follow step 230 have already been described hereinabove, and are shown in FIG. 2.

Still referring to FIG. 2, and returning to step 220, in an embodiment, if the container platform service 180 has a non-operational result, the task scheduler 130 proceeds at step 270 to check whether the instance of combined services CR 170 on the container runtime service 160 is operational. Steps in the cycle 200 that follow step 270 have already been described hereinabove, and are shown in FIG. 2.

Operation of the framework 100 (in FIG. 1) has been described hereinabove. However, before the framework 100 can operate as described, the components of the framework 100 must be installed and deployed on the operating system 110 (in FIG. 1) of the local host 120 (in FIG. 1). In an embodiment, the one or more data processors 122 (in FIG. 1) perform further operations prior to executing the task scheduler 130 or the deployer daemon 140, for example, including executing a deployment script 300. Referring to FIG. 3, in an embodiment, steps executed by the deployment script 300 are illustrated.

In an embodiment, starting at step 310, the deployment script 300 identifies the operating system 110 (in FIG. 1) of the local host 120 (in FIG. 1) and updates the results file 197 with an indication of the type of operating system 110. At step 320, in an embodiment, the deployment script 300 prepares directories on the operating system 110 including paths for storage of the task scheduler 130 (in FIG. 1), the deployer daemon 140 (in FIG. 1), the container runtime service 160 (in FIG. 1), and instances of the combined services 150, 170, 190 (in FIG. 1). In an embodiment, the deployment script 300 updates the results file 197 with an indication of the paths for storage. At step 330, in an embodiment, the deployment script 300 prepares the task scheduler 130 and the deployer daemon 140 for deployment on the identified operating system 110 identified in step 310, and places the task scheduler 130 and the deployer daemon 140 in the path prepared in step 320. At step 330, in an embodiment, the deployment script 300 also updates the results file 197 with an indication of a success or failure of preparing and placing the task scheduler 130 and deployer daemon 140. At step 340, in an embodiment, the deployment script 300 deploys the task scheduler 130 and the deployer daemon 140. Initial launch of the task scheduler 130 triggers a checking mechanism to complete initial deployment at least one instance of the combined services 150, 170, 190. At step 340, in an embodiment, the deployment script 300 also updates the results file 197 with a success or failure of the deployment of the task scheduler 130 and the deployer daemon 140.

In an embodiment the results file 197 is stored on the local host 120. In an embodiment the results file 197 is generated as a hidden path file in the path where the deployment script 300 is executed. In an embodiment the results file 197 contains two parts. The first part of the results file 197, in an embodiment, comprises deployment result records that are recorded in fields labeled “INFO1” through “INFO4.” The fields “INFO1” through “INFO4” respectively include the results of steps 310 through 340 as written to the results file 197 by the deployment script 300 illustrated in FIG. 3.

The second part of the results file 197, in an embodiment, comprises an operational result record that is recorded in a single field labeled “STDX,” where the X can be any integer value from 1 to 6. The field “STDX” includes the result of the last execution of the cycle of operational checks 200 illustrated in FIG. 2. As described further below, in an embodiment, the value of X is determined by the step of the cycle 200 last executed before the end of the cycle 200. The results file 197 includes only one “STDX” field because, upon execution of the cycle 200, the contents of the “STDX” field, if any, in the results file 197 is overwritten by the latest result from the cycle 200.

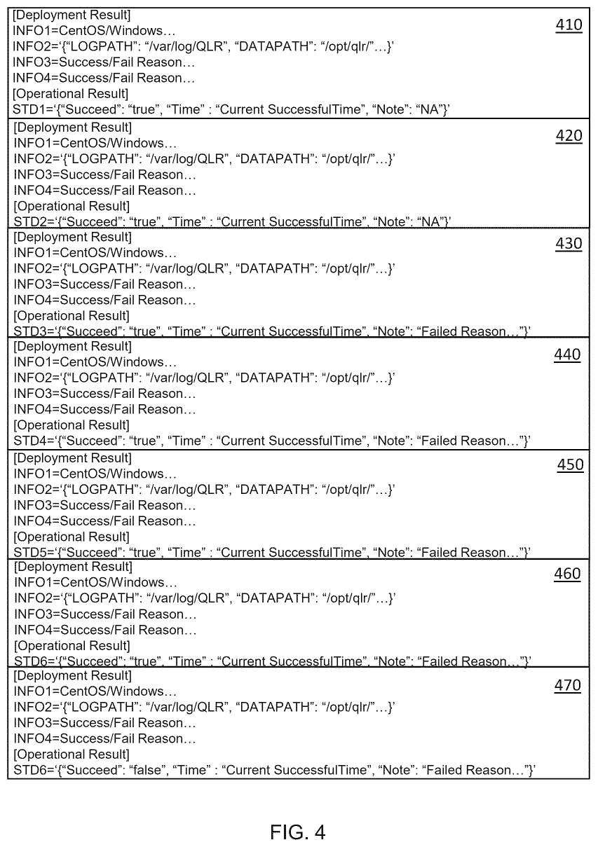

Referring to FIG. 4, seven examples of the results file 197 (in FIG. 1) are illustrated as deployment result files 410, 420, 430, 440, 450, 460, and 470. In these example deployment results files, the results file 197 is formatted in Tom's Obvious Minimal Language (TOML) format, where the “INFO2” and “STDX” fields within the results file 197 are in a JavaScript® Object Notation (JSON) format. The purpose of using JSON format is just to ensure readability and easy parsing. In other embodiments, the “INFO2” and “STDX” fields can be recorded in TOML format without using JSON format. However, considering that the log format of containers is usually set to JSON format in most cases, setting the “INFO2” and “STDX” fields to JSON format makes it convenient for users to check the content of results file 197. Other formats for the results file 197 and/or any of the fields therein may be used. The generation of the seven example deployment result files 410-470 is discussed more fully hereinbelow.

Referring to FIGS. 3 and 4, all of the example deployment result files 410-470 of FIG. 4 illustrate the result of execution in an exemplary system environment of a single exemplary deployment script 300 as illustrated in FIG. 3. At step 310, the exemplary deployment script 300 identified the operating system 110 (in FIG. 1) to be CentOS. Therefore, the INFO1 field entry in the example deployment result files 410-470 of FIG. 4 indicates the operating system identified at step 310 as “INFO1=CentOS/Windows.” At step 320, the exemplary deployment script prepared directories on the operating system 110 including paths for storage of the task scheduler 130 (in FIG. 1) and the deployer daemon 140 (in FIG. 1). Therefore, the INFO2 field entry in the example deployment result files 410-470 indicates the directory paths prepared for storage, for example, as “INFO2=‘{“LOGPATH”:“/var/log/QLR”, “DATAPATH”:“/opt/qlr/” . . . }’.”

At step 330, the exemplary deployment script 300 prepared the task scheduler 130 and the deployer daemon 140 for deployment on the identified operating system 110 identified in step 310, and placed the task scheduler 130 and the deployer daemon 140 in the directory path prepared in step 320. Therefore, the INFO3 field entry in the example deployment result files 410-470 indicates the success or failure of the deployment and placement in the step 330, for example, as “INFO3=Success” or “INFO3=Failure.”

The INFO3 field entry can include a reason for the failure. In fact any of the fields labeled “INFO1” through “INFO4” can include a reason for failure. In this context, the failure of step 330 can come from failed results of step 310 or step 320. For example, at step 310 the exemplary deployment script 300 may not identify the operating system 110 (in FIG. 1). Or, at step 320, the exemplary deployment script 300 may not successfully prepare the directories, which can happen because the current operating system has customized security or firewall settings, which makes it impossible to create the corresponding directory structure on the default path. In this circumstance, the INFO 3 field entry will include the reason for failure to be “cannot create directory: Permission Denied.” Further, the results of failure of any of steps 310, 320, 330, or 340 will be recorded in the fields labeled “INFO1” through “INFO4,” respectively of the results file 197. Any of the above situations may cause step 330 to be unable to deploy the files required by the combined services 150, 170, 190 to the system environment.

Continuing, at step 340, the exemplary deployment script 300 deployed the task scheduler 130 and the deployer daemon 140. Therefore, the INFO4 field entry in the example deployment result files 410-470 indicates the success or failure of deployment of the task scheduler 130 and the deployer daemon 140 in step 340, for example, as “INFO4=Success” or “INFO4=Failure.” The INFO 4 field entry can include a reason for the failure, for example, the reason for failure can be “Scheduler error,” or a reason indicative of the system environment having customized security or firewall permission restrictions.

Referring to FIGS. 2 and 4, the operational result field labeled as “STDX” in each of the example deployment result files 410-460 has a different entry, presented as “STD1” through “STD6.” The operational result field “STDX” is the same, “STD6,” in both of the example deployment files 460 and 470 as is explained below. Whenever the operational result field “STDX” is updated by the task scheduler 130, any prior entry therein is deleted. The contents of the operational result field labeled as “STDX” in each of the example deployment result files 410-470 is generated by following a different path through the cycle 200. In particular, as explained more fully below, the value of X in the “STDX” field of the results file 197 is determined by the step of the cycle 200 last executed before the end of the cycle 200.

Still referring to FIGS. 2 and 4, each of the example deployment result files 410-460 is generated by taking a different path through the cycle of operational checks 200. For example, if the operational result field “STDX” is updated at step 252 of the cycle 200 in FIG. 2, the value of X is set to 1. Therefore, as example 410 in FIG. 4 indicates, the “STDX” field is written, for example, as “STD1=‘{“Succeed”:“true”, “Time”:“Current SuccessfulTime”, “Note”:“NA”}’.” In other embodiments, the contents of the “STD1” field can be different. Thus, the example 410 shows the results file 197 when the cycle 200 of operational checks shows that the container runtime service 160 (in FIG. 1) and the container platform service 180 (in FIG. 1) are operational, and further that the instance of combined services CP 190 (in FIG. 1) on the container platform service 180 is operational. This result is indicative that the combined services CP 190 is receiving log entries from the servers 194 (in FIG. 1) and the data storage systems 196 (in FIG. 1) in the cloud 193 (in FIG. 1).

If the operational result field “STDX” is updated at step 264 of the cycle 200 in FIG. 2, the value of X is set to 2. Therefore, as example 420 in FIG. 4 indicates, the “STDX” field is written, for example, as “STD2=‘{“Succeed”:“true”, “Time”:“Current SuccessfulTime”, “Note”:“NA”}’.” In other embodiments, the contents of the “STD2” field can be different. Thus, the example 420 shows the results file 197 when the cycle 200 of operational checks shows that the container runtime service 160 and the container platform service 180 are operational. The example 420 further shows that the instance of combined services CP 190 on the container platform service 180 was not operational, but was installed and deployed at step 260, and is now operational. This result is indicative that the combined services CP 190 is receiving log entries from the servers 194 and the data storage systems 196 in the cloud 193

If the operational result field “STDX” is updated at step 272 of the cycle 200 in FIG. 2, the value of X is set to 3. Therefore, as example 430 in FIG. 4 indicates, the “STDX” field is written, for example, as “STD3=‘{“Succeed”:“true”, “Time”:“Current SuccessfulTime”, “Note”:“Failed Reason . . . ”}’.” In other embodiments, the contents of the “STD3” field can be different. Thus, the example 430 shows the results file 197 when the cycle 200 of operational checks shows that the container runtime service 160 is operational. The example 430 further shows that the instance of combined services CR 170 (in FIG. 1) on the container runtime service 160 is operational. This operational status can be coincident with a non-operational status for either the container platform service 180 or the instance of combined services CP 190 on the container platform service 180. This result is further indicative that the combined services CR 170 is receiving log entries from the container runtime service 160.

If the operational result field “STDX” is updated at step 284 of the cycle 200 in FIG. 2, the value of X is set to 4. Therefore, as example 440 in FIG. 4 indicates, the “STDX” field is written, for example, as “STD4=‘{“Succeed”:“true”, “Time”:“Current SuccessfulTime”, “Note”:“Failed Reason . . . ”}’.” In other embodiments, the contents of the “STD4” field can be different. Thus, the example 440 shows the results file 197 when the cycle 200 of operational checks shows that the container runtime service 160 is operational. The example 440 further shows that the instance of combined services CR 170 on the container runtime service 160 was not operational, but was installed and deployed at step 280, and is now operational. This operational status can be coincident with a non-operational status for either the container platform service 180 or the instance of combined services CP 190 on the container platform service 180. This result is further indicative that the combined services CR 170 is receiving log entries from the container runtime service 160.

If the operational result field “STDX” is updated at step 232 of the cycle 200 in FIG. 2, the value of X is set to 5. Therefore, as example 450 in FIG. 4 indicates, the “STDX” field is written, for example, as “STD5=‘{“Succeed”:“true”, “Time”:“Current SuccessfulTime”, “Note”:“Failed Reason . . . ”}’.” In other embodiments, the contents of the “STD5” field can be different. Thus, the example 450 shows the results file 197 when the cycle 200 of operational checks shows that neither the container runtime service 160 nor the container platform service 180 is operational. The example 450 further shows that the instance of combined services OS 150 (in FIG. 1) on the operating system 110 (in FIG. 1) is operational. This result is further indicative that combined services OS 150 is receiving log entries from the operating system 110.

If the operational result field “STDX” is updated at step 244 of the cycle 200 in FIG. 2, the value of X is set to 6. If the field “STD6” is updated via step 244, this is indicative that the instance of combined services OS 150 on the operating system 110 was successfully deployed and is operational. Therefore, as example 460 in FIG. 4 indicates, the “STDX” field is written, for example, as “STD6=‘{“Succeed”:“true”, “Time”:“Current SuccessfulTime”, “Note”:“Failed Reason . . . ”}’.” In other embodiments, the contents of the “STD6” field can be different. Thus, the example 460 shows the results file 197 when the cycle 200 of operational checks shows that neither the container runtime service 160 nor the container platform service 180 is operational. The example 460 further shows that the instance of combined services OS 150 on the operating system 110 was not operational, but was installed and deployed at step 240, and is now operational. This result is further indicative that the combined services OS 150 is receiving log entries from the operating system 110.

However, if the field “STD6” is updated via step 246, this is indicative that deployment of the combined services OS 150 on the operating system 110 has failed, and the instance of combined services OS 150 on the operating system 110 is not operational. Therefore, as example 470 in FIG. 4 indicates, the “STDX” field is written, for example, as sh37 STD6=‘{“Succeed”:“false”, “Time”:“2024-06-17T02:53:18.332761052Z”, “Note”:“Failed to deploy Combined Services OS 150 due to . . . ”}’. In this example, Succeed is false, and Time refers to the last time combined services OS 150 was successfully deployed. In other embodiments, the contents of the “STD6” field can be different.

Thus, the example 470 shows the results file 197 when the cycle 200 of operational checks shows that neither the container runtime service 160 nor the container platform service 180 is operational. The example 470 further shows that the instance of combined services OS 150 on the operating system 110 was not operational, was installed and deployed at step 240, and is still not operational. This result is further indicative that none of the combined services 150, 170, 190 is operating to receive log entries.

The flow diagrams in FIGS. 2 and 3 are representative of example machine readable instructions for the processes deploying and initiating the components of the framework 100 (in FIG. 1), including the deployment script 300, the task scheduler, 130, the deployer daemon 140 (in FIG. 1), and also instances of the combined services 150, 170, 190 (in FIG. 1). In these examples, the machine readable instructions comprise an algorithm for execution by: (a) a processor; (b) a controller; and/or (c) one or more other suitable processing device(s). The algorithm may be embodied in software stored on tangible media such as flash memory, CD-ROM, floppy disk, hard drive, digital video (versatile) disk (DVD), or other memory devices. However, persons of ordinary skill in the art will readily appreciate that the entire algorithm and/or parts thereof can alternatively be executed by a device other than a processor and/or embodied in firmware or dedicated hardware in a well-known manner (e.g., it may be implemented by an application specific integrated circuit [ASIC], a programmable logic device [PLD], a field programmable logic device [FPLD], a field programmable gate array [FPGA], discrete logic, etc.). For example, any or all of the components of the interfaces can be implemented by software, hardware, and/or firmware. Also, some or all of the machine readable instructions represented by the flow diagrams may be implemented manually. Further, although the example algorithm is described with reference to the flowcharts illustrated in FIGS. 2 and 3, persons of ordinary skill in the art will readily appreciate that many other methods of implementing the example machine readable instructions may alternatively be used. For example, the order of execution of the blocks may be changed, and/or some of the blocks described may be changed, eliminated, or combined.

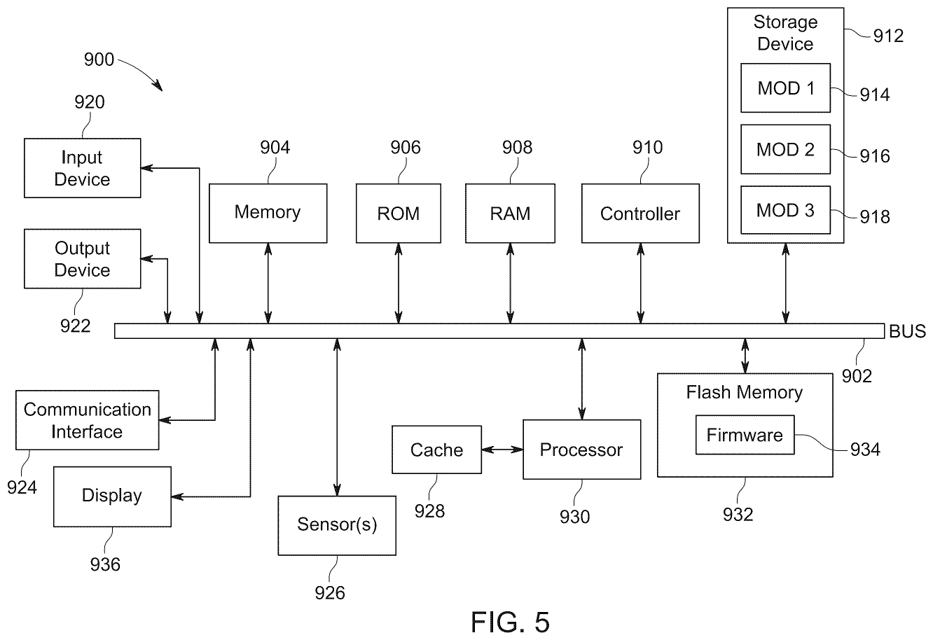

FIG. 5 illustrates an example computing system 500, which can be representative of the local host 120 shown in FIG. 1. The components of the computing system 500 are in electrical communication with each other using a bus 502. The system 500 includes a processing unit (CPU or processor) 530; which are analogous to the one or more data processors 122 in FIG. 1. The system 500 includes a system bus 502 that couples various system components, including the system memory 504 (e.g., read only memory (ROM) 506 and random access memory (RAM) 508), to the processor 530. The system 500 can include a cache of high-speed memory connected directly with, in close proximity to, or integrated as part of the processor 530. The system 500 includes a storage device 512 analogous to the non-transitory computer-readable storage medium 195 shown in FIG. 1.

The system 500 can, for example, copy data from the memory 504 and/or the storage device 512 to the cache 528 for quick access by the processor 530. In this way, the cache can provide a performance boost for processor 530 while waiting for data. These and other modules can control or be configured to control the processor 530 to perform various actions. Other system memory 504 may be available for use as well. The memory 504 can include multiple different types of memory with different performance characteristics. The processor 530 can include any general purpose processor and a hardware module or software module, such as module 1 514, module 2 516, and module 3 518 embedded in storage device 512. The hardware module or software module is configured to control the processor 530, as well as a special-purpose processor where software instructions are incorporated into the actual processor design. The processor 530 may essentially be a completely self-contained computing system that contains multiple cores or processors, a bus, memory controller, cache, etc. A multi-core processor may be symmetric or asymmetric.

To enable user interaction with the computing device 500, an input device 520, for example, is provided as an input mechanism. The input device 520 can comprise a microphone for speech, a touch-sensitive screen for gesture or graphical input, keyboard, mouse, motion input, and so forth. In some instances, multimodal systems can enable a user to provide multiple types of input to communicate with the system 500. In this example, an output device 522 is also provided. The communications interface 524 can govern and manage the user input and system output.

Storage device 512, which is generally representative of the non-transitory computer-readable storage medium 195, can be a non-volatile memory to store data that is accessible by a computer. The storage device 512 can be magnetic cassettes, flash memory cards, solid state memory devices, digital versatile disks, cartridges, random access memories (RAMs) 508, read only memory (ROM) 506, and hybrids thereof.

The controller 510 can be a specialized microcontroller or processor on the system 500, such as a BMC (baseboard management controller). In some cases, the controller 510 can be part of an Intelligent Platform Management Interface (IPMI). Moreover, in some cases, the controller 510 can be embedded on a motherboard or main circuit board of the system 500. The controller 510 can manage the interface between system management software and platform hardware. The controller 510 can also communicate with various system devices and components (internal and/or external), such as controllers or peripheral components, as further described below.

The controller 510 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 510 to initiate or conduct specific hardware recovery procedures or operations, as further described below.

The controller 510 can also include a system event log controller and/or storage for managing and maintaining events, alerts, and notifications received by the controller 510. For example, the controller 510 or a system event log controller can receive alerts or notifications from one or more devices and components, and maintain the alerts or notifications in a system event log storage component.

Flash memory 532 can be an electronic non-volatile computer storage medium or chip that can be used by the system 500 for storage and/or data transfer. The flash memory 532 can be electrically erased and/or reprogrammed. Flash memory 532 can include EPROM (erasable programmable read-only memory), EEPROM (electrically erasable programmable read-only memory), ROM, NVRAM, or CMOS (complementary metal-oxide semiconductor), for example. The flash memory 532 can store the firmware 534 executed by the system 500 when the system 500 is first powered on, along with a set of configurations specified for the firmware 534. The flash memory 532 can also store configurations used by the firmware 534.

The firmware 534 can include a Basic Input/Output System or equivalents, such as an EFI (Extensible Firmware Interface) or UEFI (Unified Extensible Firmware Interface). The firmware 534 can be loaded and executed as a sequence program each time the system 500 is started. The firmware 534 can recognize, initialize, and test hardware present in the system 500 based on the set of configurations. The firmware 534 can perform a self-test, such as a POST (Power-On-Self-Test), on the system 500. This self-test can test the functionality of various hardware components such as hard disk drives, optical reading devices, cooling devices, memory modules, expansion cards, and the like. The firmware 534 can address and allocate an area in the memory 504, ROM 506, RAM 508, and/or storage device 512, to store an operating system (OS). The firmware 534 can load a boot loader and/or OS, and give control of the system 500 to the OS.

The firmware 534 of the system 500 can include a firmware configuration that defines how the firmware 534 controls various hardware components in the system 500. The firmware configuration can determine the order in which the various hardware components in the system 500 are started. The firmware 534 can provide an interface, such as an UEFI, that allows a variety of different parameters to be set, which can be different from parameters in a firmware default configuration. For example, a user (e.g., an administrator) can use the firmware 534 to specify clock and bus speeds; define what peripherals are attached to the system 500; set monitoring of health (e.g., fan speeds and CPU temperature limits); and/or provide a variety of other parameters that affect overall performance and power usage of the system 500. While firmware 534 is illustrated as being stored in the flash memory 532, one of ordinary skill in the art will readily recognize that the firmware 534 can be stored in other memory components, such as memory 504 or ROM 506.

System 500 can include one or more sensors 526. The one or more sensors 526 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 526 can communicate with the processor, cache 528, flash memory 532, communications interface 524, memory 504, ROM 506, RAM 508, controller 510, and storage device 512, via the bus 502, for example. The one or more sensors 526 can also communicate with other components in the system via one or more different means, such as inter-integrated circuit (I2C), general purpose output (GPO), and the like. Different types of sensors (e.g., sensors 526) on the system 500 can also report to the controller 510 on parameters, such as cooling fan speeds, power status, operating system (OS) status, hardware status, and so forth. A display 536 may be used by the system 500 to provide graphics related to the applications that are executed by the controller 510.

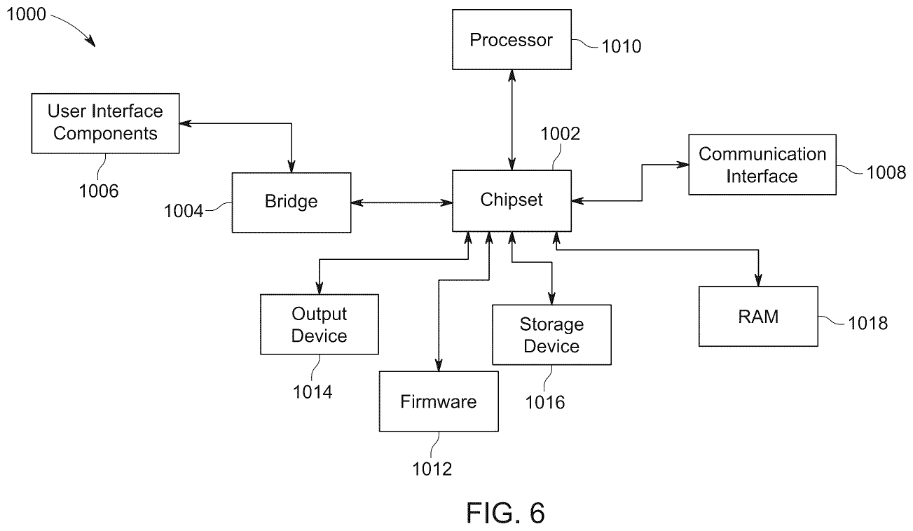

FIG. 6 illustrates an example computer system 600 having a chipset architecture that can be used in executing the described method(s) or operations, and generating and displaying a graphical user interface (GUI). Computer system 600 can include computer hardware, software, and firmware that can be used to implement the disclosed technology. System 600 can include a processor 610, representative of a variety of physically and/or logically distinct resources capable of executing software, firmware, and hardware configured to perform identified computations. Processor 610 can communicate with a chipset 602 that can control input to and output from processor 610. Processor 610 is analogous to the one or more data processors 122 in FIG. 1.

In this example, chipset 602 outputs information to output device 614, such as a display, and can read and write information to storage device 616. The storage device 616 is analogous to the non-transitory computer-readable storage medium 195 shown in FIG. 1. The storage device 616 can include magnetic media, and solid state media, for example. Chipset 602 can also read data from and write data to RAM 618. A bridge 604 for interfacing with a variety of user interface components 606, can be provided for interfacing with chipset 602. User interface components 606 can include a keyboard, a microphone, touch detection and processing circuitry, and a pointing device, such as a mouse.

Chipset 602 can also interface with one or more communication interfaces 608 that can have different physical interfaces. Such communication interfaces can include interfaces for wired and wireless local area networks, for broadband wireless networks, and for personal area networks. Further, the machine can receive inputs from a user via user interface components 606, and execute appropriate functions, such as browsing functions by interpreting these inputs using processor 610.

Moreover, chipset 602 can also communicate with firmware 612, which can be executed by the computer system 600 when powering on. The firmware 612 can recognize, initialize, and test hardware present in the computer system 600 based on a set of firmware configurations. The firmware 612 can perform a self-test, such as a POST, on the system 600. The self-test can test the functionality of the various hardware components 602-618. The firmware 612 can address and allocate an area in the memory 618 to store an OS. The firmware 612 can load a boot loader and/or OS, and give control of the system 600 to the OS. In some cases, the firmware 612 can communicate with the hardware components 602-610 and 614-618. Here, the firmware 612 can communicate with the hardware components 602-610 and 614-618 through the chipset 602, and/or through one or more other components. In some cases, the firmware 612 can communicate directly with the hardware components 602-610 and 614-618.

It can be appreciated that example systems 500 (in FIGS. 5) and 600 (in FIG. 6) can have more than one processor (e.g., 530, 610), for example, or the one or more processors 122 in FIG. 1, or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware; generalized hardware made specialized by the execution of software thereon that enables the hardware to perform specific function; software stored on a computer-readable medium; or a combination thereof.

Although the disclosed embodiments have been illustrated and described with respect to one or more implementations, equivalent alterations and modifications will occur or be known to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

While various embodiments of the present disclosure have been described above, it should be understood that they have been presented by way of example only, and not limitation. Numerous changes to the disclosed embodiments can be made in accordance with the disclosure herein, without departing from the spirit or scope of the disclosure. Thus, the breadth and scope of the present disclosure should not be limited by any of the above described embodiments. Rather, the scope of the disclosure should be defined in accordance with the following claims and their equivalents.

What is claimed is:

1. A system comprising:
one or more data processors; and
a non-transitory computer-readable storage medium containing instructions which, when executed on the one or more data processors, cause the one or more data processors to perform operations including:
executing a deployer daemon on an operating system of a local host to maintain operation of at least one instance of a combined services, the combined services including a log collection service and a storage and retrieval service;
performing, via a task scheduler executing on the operating system, a cycle of operational status checks on the combined services;
repeating the cycle at a predetermined time interval;
triggering, via the task scheduler, the deployer daemon to correct a non-operational result if the operational status check returns the non-operational result; and
adding an entry, via the task scheduler, into a results file indicative of corrective action taken.

2. The system of claim 1, wherein the operations further include performing the cycle of operational status checks on instances of the combined services, the instances including at least one of a first instance, a second instance, and a third instance, the first instance being configured to operate on a container platform service on a container runtime service on the operating system, the second instance being configured to operate on the container runtime service on the operating system, and the third instance being configured to operate on the operating system.

3. The system of claim 2, wherein each cycle begins with a check of whether the container runtime service is operational, the task scheduler performing an operational status check on the container platform service if the container runtime service is operational.

4. The system of claim 3, wherein in response to the container runtime service having a non-operational result, the operations further include:
proceeding to check, via the task scheduler, whether the third instance of the combined services is operational;
in response to the third instance of the combined services being operational, updating, via the task scheduler, a results file with an indication that the third instance of the combined services is operational to end the cycle;
in response to the third instance of the combined services being not operational,
executing, via the task scheduler, the deployer daemon to install and deploy the third instance of the combined services, the task scheduler checking whether the third instance of the combined services is operational; and
updating, via the task scheduler, the results file with an indication of whether the third instance of the combined services was deployed and is operational, the updating ending the cycle.

5. The system of claim 3, wherein in response to the container platform service being operational, the operations further include performing, via the task scheduler, a sequence of four steps on each of the first, second, and third instances of the combined services, in sequential order and as needed, until at least one of the first, second, and third instances is operational, the sequence of the four steps including:
a first step in which the results file is updated and the cycle ends in response to a first checking determining that the combined services are operational;
a second step in which the deployer daemon is executed to install and deploy the combined services, in response to the first checking determining that the combined services are not operational;
a third step in which the results file is updated and the cycle ends in response to a second checking determining that the combined services are operational; and
a fourth step in which the instance being checked is incremented, the results file being updated and the cycle ending if the third instance has failed, the sequence returning to the first step if the third instance has not failed.

6. The system of claim 3, wherein in response to the container platform service not being operational, the operations further include performing, via the task scheduler, a sequence of four steps on each of the second and third instances of the combined services, in order and as needed, until at least one of the second and third instances is operational, the sequence of the four steps including:
a first step in which the results file is updated and the cycle ends in response to a first checking determining that the combined services are operational;
a second step in which the deployer daemon is executed to install and deploy the combined services, in response to the first checking determining that the combined services are not operational;
a third step in which the results file is updated and the cycle ends in response to a second checking determining that the combined services are operational; and
a fourth step in which the instance being checked is incremented, the results file being updated and the cycle ending if the third instance has failed, the sequence returning to the first step if the third instance has not failed.

7. The system of claim 1, wherein the one or more data processors perform further operations prior to executing the task scheduler or the deployer daemon, including executing a deployment script configured to:
D1) identify the operating system of the local host and update the results file with an indication of the operating system;
D2) prepare directories on the operating system including paths for storage of the task scheduler and the deployer daemon, and update the results file with an indication of the paths;
D3) prepare the task scheduler and the deployer daemon for deployment on the identified operating system identified in D1), place the task scheduler and the deployer daemon in the path prepared in D2), and update the results file with an indication of a success or failure of the preparing and placing; and
D4) deploy the task scheduler and the deployer daemon and update the results file with a success or failure of the deploying.

8. A computer-implemented method, comprising:
executing a deployer daemon on an operating system of a local host to maintain operation of at least one instance of a combined services, the combined services including a log collection service and a storage and retrieval service;
executing a task scheduler on the operating system, the task scheduler performing a cycle of operational status checks on the combined services, the cycle repeating at a predetermined time interval; and
triggering, via the task scheduler, the deployer daemon to correct a non-operational result if the operational status check returns the non-operational result, an entry being added into a results file to indicate a taken corrective action.

9. The method of claim 8, wherein the cycle of operational status checks is performed on instances of the combined services, including at least one of a first instance, a second instance, and a third instance, the first instance being configured to operate on a container platform service on a container runtime service on the operating system, the second instance being configured to operate on the container runtime service on the operating system, and the third instance being configured to operate on the operating system.

10. The method of claim 9, wherein each cycle begins with a check of whether the container runtime service is operational, the task scheduler performing an operational status check on the container platform service in response to the container runtime service being operational.

11. The method of claim 10, wherein in response to the container runtime service having a non-operational result:
Proceeding to check, via the task scheduler, whether the third instance of the combined services is operational;
in response to the third instance of the combined services being operational, updating, via the task scheduler, a results file with an indication that the third instance of the combined services is operational to end the cycle;
in response to the third instance of the combined services being not operational,
executing, via the task scheduler, the deployer daemon to install and deploy the third instance of the combined services, the task scheduler checking whether the third instance of the combined services is operational; and
updating, via the task scheduler, the results file with an indication of whether the third instance of the combined services was deployed and is operational, the updating ending the cycle.

12. The method of claim 10, wherein in response to the container platform service being operational, performing, via the task scheduler, a sequence of four steps on each of the first, second, and third instances of the combined services, in sequential order and as needed, until at least one of the first, second, and third instances is operational, the sequence of the four steps including:
a first step in which the results file is updated and the cycle ends in response to a first checking determining that the combined services are operational;
a second step in which the deployer daemon is executed to install and deploy the combined services, in response to the first checking determining that the combined services are not operational;
a third step in which the results file is updated and the cycle ends in response to a second checking determining that the combined services are operational; and
a fourth step in which the instance being checked is incremented, the results file being updated and the cycle ending if the third instance has failed, the sequence returning to the first step if the third instance has not failed.

13. The method of claim 10, wherein in response to the container platform service not being operational, further performing, via the task scheduler, a sequence of four steps on each of the second and third instances of the combined services, in order and as needed, until at least one of the second and third instances is operational, the sequence of the four steps including:
a first step in which the results file is updated and the cycle ends in response to a first checking determining that the combined services are operational;
a second step in which the deployer daemon is executed to install and deploy the combined services, in response to the first checking determining that the combined services are not operational;
a third step in which the results file is updated and the cycle ends in response to a second checking determining that the combined services are operational; and
a fourth step in which the instance being checked is incremented, the results file being updated and the cycle ending if the third instance has failed, the sequence returning to the first step if the third instance has not failed.

14. The method of claim 8, further comprising one or more operations prior to executing the task scheduler or the deployer daemon, including executing a deployment script, wherein the deployment script:
D1) identifies the operating system of the local host and updates the results file with an indication of the operating system;
D2) prepares directories on the operating system including paths for storage of the task scheduler and the deployer daemon, and updates the results file with an indication of the paths;
D3) prepares the task scheduler and the deployer daemon for deployment on the identified operating system identified in D1), places the task scheduler and the deployer daemon in the path prepared in D2), and updates the results file with an indication of a success or failure of the preparing and placing; and
D4) deploys the task scheduler and the deployer daemon and updates the results file with a success or failure of the deploying.

15. A computer-program product tangibly embodied in a non-transitory machine-readable storage medium, including instructions configured to cause a data processing apparatus to perform operations including:
executing a deployer daemon on an operating system of a local host to maintain operation of at least one instance of a combined services, the combined services including a log collection service and a storage and retrieval service;
performing, via a task scheduler executing on the operating system, a cycle of operational status checks on the combined services;
repeating the cycle at a predetermined time interval;
triggering, via the task scheduler, the deployer daemon to correct a non-operational result if the operational status check returns the non-operational result; and
adding an entry, via the task scheduler, into a results file indicative of corrective action taken.

16. The computer-program product of claim 15, wherein the operations further include performing the cycle of operational status checks on instances of the combined services, the instances including at least one of a first instance, a second instance, and a third instance, the first instance being configured to operate on a container platform service on a container runtime service on the operating system, the second instance being configured to operate on the container runtime service on the operating system, and the third instance being configured to operate on the operating system.

17. The computer-program product of claim 16, wherein each cycle begins with a check of whether the container runtime service is operational, the task scheduler performing an operational status check on the container platform service if the container runtime service is operational, wherein in response to the container runtime service having a non-operational result, the operations further include:
proceeding to check, via the task scheduler, whether the third instance of the combined services is operational;
in response to the third instance of the combined services being operational, updating, via the task scheduler, a results file with an indication that the third instance of the combined services is operational to end the cycle;
in response to the third instance of the combined services being not operational,
executing, via the task scheduler, the deployer daemon to install and deploy the third instance of the combined services, the task scheduler checking whether the third instance of the combined services is operational; and
updating, via the task scheduler, the results file with an indication of whether the third instance of the combined services was deployed and is operational, the updating ending the cycle.

18. The computer-program product of claim 17, wherein in response to the container platform service being operational, the operations further include performing, via the task scheduler, a sequence of four steps on each of the first, second, and third instances of the combined services, in sequential order and as needed, until at least one of the first, second, and third instances is operational, the sequence of the four steps including:
a first step in which the results file is updated and the cycle ends in response to a first checking determining that the combined services are operational;
a second step in which the deployer daemon is executed to install and deploy the combined services, in response to the first checking determining that the combined services are not operational;
a third step in which the results file is updated and the cycle ends in response to a second checking determining that the combined services are operational; and
a fourth step in which the instance being checked is incremented, the results file being updated and the cycle ending if the third instance has failed, the sequence returning to the first step if the third instance has not failed.

19. The computer-program product of claim 17, wherein in response to the container platform service not being operational, the operations further include performing, via the task scheduler, a sequence of four steps on each of the second and third instances of the combined services, in order and as needed, until at least one of the second and third instances is operational, the sequence of the four steps including:
a first step in which the results file is updated and the cycle ends in response to a first checking determining that the combined services are operational;
a second step in which the deployer daemon is executed to install and deploy the combined services, in response to the first checking determining that the combined services are not operational;
a third step in which the results file is updated and the cycle ends in response to a second checking determining that the combined services are operational; and
a fourth step in which the instance being checked is incremented, the results file being updated and the cycle ending if the third instance has failed, the sequence returning to the first step if the third instance has not failed.

20. The computer-program product of claim 15, further configured to cause the data processing apparatus to perform one or more operations prior to executing the task scheduler or the deployer daemon, including executing a deployment script configured to:
D1) identify the operating system of the local host and update the results file with an indication of the operating system;
D2) prepare directories on the operating system including paths for storage of the task scheduler and the deployer daemon, and update the results file with an indication of the paths;
D3) prepare the task scheduler and the deployer daemon for deployment on the identified operating system identified in D1), place the task scheduler and the deployer daemon in the path prepared in D2), and update the results file with an indication of a success or failure of the preparing and placing; and
D4) deploy the task scheduler and the deployer daemon and update the results file with a success or failure of the deploying.
